(19) United States
(12) Patent Application Publication
(10) Pub. No.: US 2011/0112895 A1
(43) Pub. Date: May 12, 2011

(54) PROXIMAL GAME SHARING

(75) Inventor: Thomas D. Snyder, Cary, NC (US)

(73) Assignee: SONY ERICSSON MOBILE COMMUNICATIONS AB, Lund (SE)

(21) Appl. No.: 12/615,314

(22) Filed: Nov. 10, 2009

(51) Int. Cl. G06Q 30/00; G06F 15/16; G06Q 50/00

(52) U.S. Cl. 705/14.12; 705/14.16; 709/205; 705/26.35

(57) ABSTRACT

A device may include a network interface for communicating over a network; and a processor. The processor may obtain a list of parties that are associated with user devices proximate to the device. In addition, the processor may receive, from a participant, a selection of a party in the list of parties. Further, the processor may send a copy of a component to a first user device associated with the selected party, start an application session by running an application, and engage the first user device in the application session, over a communication link, via the component installed at the first user device.

### BACKGROUND

It is common for people to “sample” goods before they buy the goods. In stores, products are often exhibited on shelves to be viewed or examined. On the Internet, an online music store may play a song when a visitor accesses the site and display a button for the visitor to click to purchase the song.

With mobile gaming, a “sampling” experience is often not exciting to a potential purchaser. Today, many games are designed to be played by multiple players, and a simple downloadable demo may not be enticing or compelling enough to translate the demo experience into a purchase.

### SUMMARY

According to one aspect, a device may include a network interface for communicating over a network and a processor. The processor may obtain a list of parties that are associated with user devices proximate to the device and receive, from a participant, a selection of a party in the list of parties. Further, the processor may send a copy of a component to a first user device associated with the selected party, start an application session by running an application, and engage the first user device in the application session, over a communication link, via the component installed at the first user device.

Additionally, the device may further include a cellular telephone, a game console, a netbook, a laptop, a personal computer, or a personal digital assistant.

Additionally, the processor may be configured to receive descriptions of locations, from the user devices or a service provider, associated with the user devices.

Additionally, the processor may be further configured to receive information for giving credit to the participant for sending the copy of the component to the first user device, or receive information for giving credit to the participant when the selected party purchases a copy of the application.

Additionally, the component may include at least one of the application, or a controller for the application.

Additionally, the device may further include a memory for storing a contact list for the participant, the contact list including the list of parties.

Additionally, the application may include a game application, and the component may include the game application.

Additionally, the processor may be further configured to at least one of configure the copy of the game application to limit a number of times the game application is to be played on the first user device, or configure the copy of the game application to expire on a particular date.

Additionally, the processor may be further configured to determine a location of the device, and compare the location of the device to locations of the user devices.

According to another aspect, a method may include executing a game application installed on a device, obtaining a list of parties that are stored in a contact list on the device, receiving a selection of a first party in the list of parties. and generating a message including a component that is to be activated by the first party, the component causing a copy of the game application to be downloaded from a server device when the component is activated. The method may further include sending the message to a user device associated with the first party.

Additionally, the method may further include receiving credit when the first party activates the component and downloads the copy of the game application from the server device.

Additionally, receiving credit may include at least one of modifying a number of lives of a character or power of the character in the game application; receiving loyalty points, receiving a discount for a service, or receiving a cash-equivalent.

Additionally, the method may further include engaging the user device in a game via the game application.

Additionally, obtaining the list of parties may include determining locations of the parties, and identifying parties that are proximate to the participant based on the determined locations.

According to yet another aspect, a device may include a network interface for communicating over a network and a processor. The processor may be configured to receive a request from a first user device to send a copy of a game application to the first user device, the request identifying a second user device that sent, to the first user device, a message that includes a link or component whose activation caused the first user device to generate and send the request to the device. The processor may be further configured to transmit a copy of the game application to the first user device, and transmit information for conveying credit to a user associated with the second user device.

Additionally, the game application may include a multi-party network game or a single-party game.

Additionally, the credit may include a number of lives of a character or power of the character in the game application, loyalty points, a discount for a service, or a cash-equivalent.

Additionally, the second user device may include a cellular telephone, a game console, a netbook, a laptop, or a personal digital assistant.

Additionally, the processor may be further configured to transmit additional information for conveying additional credit to the user associated with the second user device when a party associated with the first user device purchases the copy of the game application.

Additionally, the processor may be further configured to configure the copy of the game application to limit a number of times the game application is to be played on the first user device, or configure the copy of the game application to expire on a particular date.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 illustrates an exemplary network in which concepts described herein may be implemented;

FIG. 2 is a diagram of an exemplary user device of FIG. 1;

FIG. 3 is a block diagram of an exemplary network device;

FIG. 4 is a block diagram of exemplary functional components of the user device of FIG. 1;

FIG. 5 is a diagram of an exemplary graphical user interface (GUI) window of component exchange logic of FIG. 4;

FIG. 6 is a block diagram of exemplary functional components of a server device of FIG. 1;

FIG. 7 is a flow diagram of an exemplary process that is associated with the user device of FIG. 1; and

FIG. 8 illustrates an example that is associated with the process of FIG. 7.

### DETAILED DESCRIPTION

The following detailed description refers to the accompanying drawings. The same reference numbers in different drawings may identify the same or similar elements. As used herein, the term “purchase” may refer to obtaining a product or service in exchange for money or its equivalent. The term “purchase” may also refer to entering into a license agreement to use a product or buying a license agreement to use a product (e.g., a software application).

In the following, a user that has purchased a game may wish to play or share the game with other players who the user knows well or who are proximal to the user. In implementations described herein, a system may allow such a user to easily share the game with other players. These other players may be influenced by the gaming experience to purchase the game.

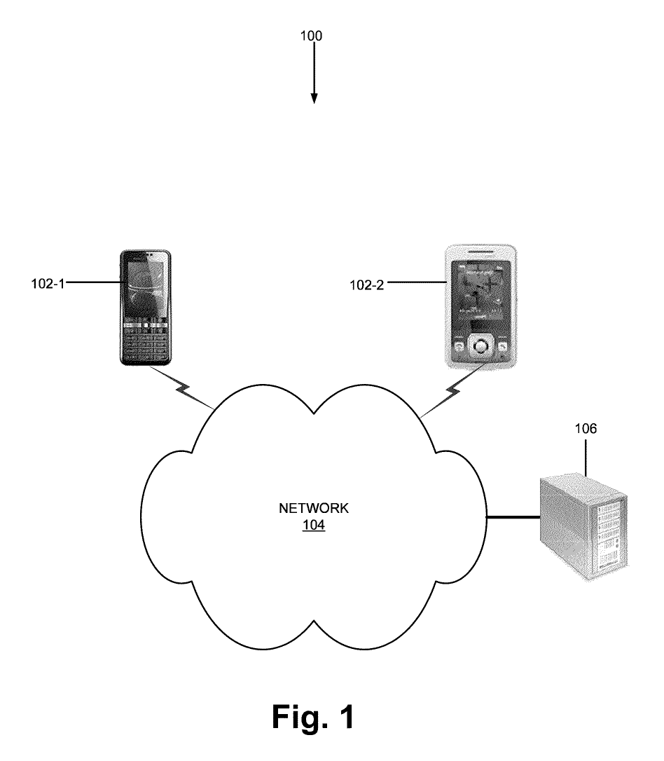

FIG. 1 is a diagram of an exemplary network 100 in which the concepts described herein may be implemented. As shown, network 100 may include user devices 102-1 and 102-2 (collectively “user devices 102” and individually “user device 102-x”), network 104, and server device 106. Depending on the implementation, network 100 may include additional, fewer, or different devices than the ones illustrated in FIG. 1. For example, in some implementations, network 100 may include hundreds, thousands, or more user devices.

User device 102-1 may facilitate sharing a game (e.g., play a game together) or obtaining a copy of a game application by user or player at user device 102-2 in. A user of user device 102-1 may have selected a player at user device 102-2 to receive a remote controller or copy of the game application based on the proximity of user device 102-2 to user device 102-1, an address book or a phone book installed on user device 102-1, or another constraint or set of criteria.

User device 102-2 may obtain a copy of controller of the game application or a copy of the game application from user device 102-1 or from server device 106.

Network 104 may include a cellular network, a public switched telephone network (PSTN), a local area network (LAN), a wide area network (WAN), a wireless LAN, a metropolitan area network (MAN), an intranet, the Internet, a satellite-based network, a fiber-optic network (e.g., passive optical networks (PONs)), an ad hoc network, any other network, or a combination of networks. User devices 102-1, user device 102-2, and server device 106 may connect to network 104 via wireless, wired, or optical communication links. In addition, network 104 may allow any of devices 102-1, 102-2 and 106 to communicate with any other device 102-1, 102-2, or 106.

Server device 106 may store a copy of the game application and/or provide a copy of the game application to other devices.

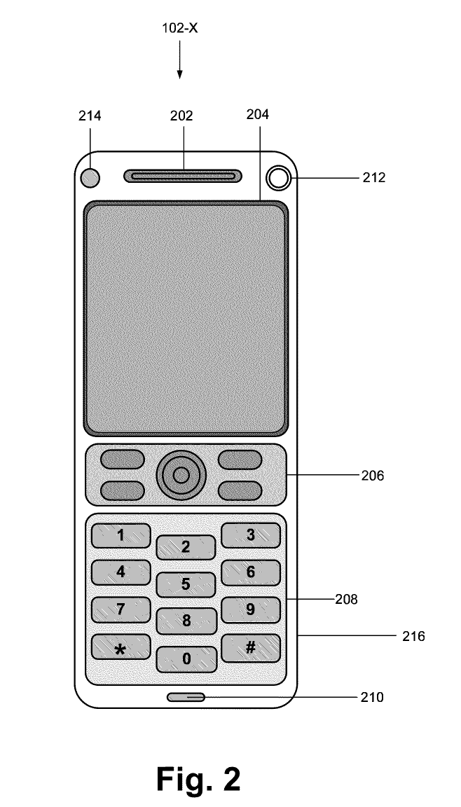

FIG. 2 is a diagram of an exemplary user device 102-x. User device 102-x may include any of the following devices: a mobile telephone; a cellular phone; a personal communications system (PCS) terminal that may combine a cellular radiotelephone with data processing, facsimile, and/or data communications capabilities; an electronic notepad, a laptop, a netbook, an ultra mobile personal computer (UMPC), and/or a personal computer; a personal digital assistant (PDA) that can include a telephone; a gaming device or console; a peripheral (e.g., wireless headphone); a digital camera; or another type of computational or communication device.

In this implementation, user device 102-x may take the form of a mobile phone (e.g., a cell phone). As shown in FIG. 2, user device 102-x may include a speaker 202, a display 204, control buttons 206, a keypad 208, a microphone 210, sensors 212, a front camera 214, and a housing 216.

Speaker 202 may provide audible information to a user of user device 102-x. Display 204 may provide visual information to the user, such as an image of a caller, video images, or pictures. In addition, display 204 may include a touch screen for providing input to user device 102-x. Control buttons 206 may permit the user to interact with user device 102-x to cause user device 102-x to perform one or more operations, such as place or receive a telephone call. Keypad 208 may include a telephone keypad. Microphone 210 may receive audible information from the user. Sensors 212 may collect and provide, to user device 102-x, information (e.g., acoustic, infrared, etc.) that is used to aid the user in capturing images or in providing other types of information (e.g., a distance between a user and user device 102-x). Front camera 214 may enable a user to view, capture and store images (e.g., pictures, video clips) of a subject in front of user device 102-x. Housing 216 may provide a casing for components of user device 102-x and may protect the components from outside elements.

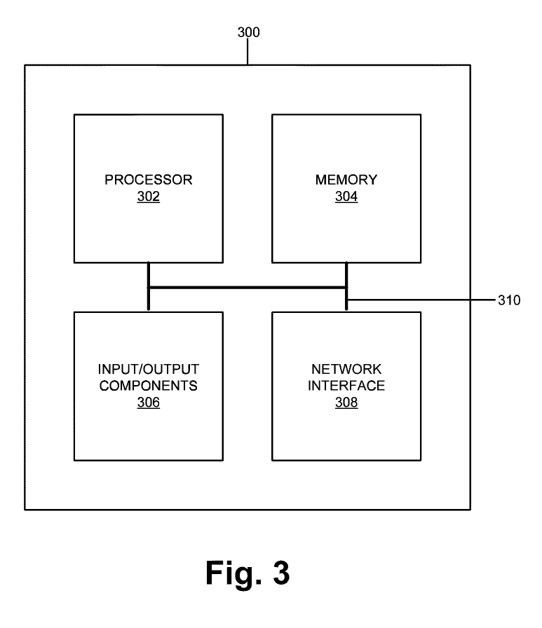

FIG. 3 is a block diagram of a network device 300, which may represent any of devices 102 and 106. As shown, network device 300 may include a processor 302, a memory 304, input/output components 306, a network interface 308, and a communication path 310. In different implementations, device 300 may include additional, fewer, or different components than the ones illustrated in FIG. 3. For example, device 300 may include additional network interfaces, such as interfaces for receiving and sending data packets.

Processor 302 may include a processor, a microprocessor, an Application Specific Integrated Circuit (ASIC), a Field Programmable Gate Array (FPGA), and/or other processing logic (e.g., audio/video processor) capable of processing information and/or controlling network device 300. Memory 304 may include static memory, such as read only memory (ROM), and/or dynamic memory, such as random access memory (RAM), or onboard cache, for storing data and machine-readable instructions. Memory 304 may also include storage devices, such as a floppy disk, CD ROM, CD read/write (R/W) disc, and/or flash memory, as well as other types of storage devices.

Input/output components 306 may include a display screen (e.g., display 204, etc.), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to network device 300. Examples of the other types of components may include a miniature electronic gyroscope for detecting the orientation of user device 102-x, an accelerometer for detecting motion of user device 102-x, and a global positioning system (GPS) receiver for receiving signals to obtain the physical location of user device 102-x. In some implementations, a combination of software/hardware components with the GPS receiver may allow user device 102-x, such as user device 102-2 to advertise, within a limited area or region, its own coordinates to another device, such as user device 102-1.

Network interface 308 may include any transceiver-like mechanism that enables network device 300 to communicate with other devices and/or systems. For example, network interface 308 may include mechanisms for communicating via a network, such as the Internet, a terrestrial wireless network (e.g., a WLAN), a cellular network, a satellite-based network, a wireless personal area network (WPAN), etc. Additionally or alternatively, network interface 308 may include a modem, an Ethernet interface to a LAN, and/or an interface/connection for connecting network device 300 to other devices (e.g., a Bluetooth interface). In some implementations, network interface 308 may enable, for example, user device 102-1 to efficiently exchange information with, for example, user device 102-2 to reduce communication delays and overhead that is associated with a larger network (e.g., Global System for Mobile Communications network).

Communication path 310 may provide an interface through which components of network device 300 can communicate with one another.

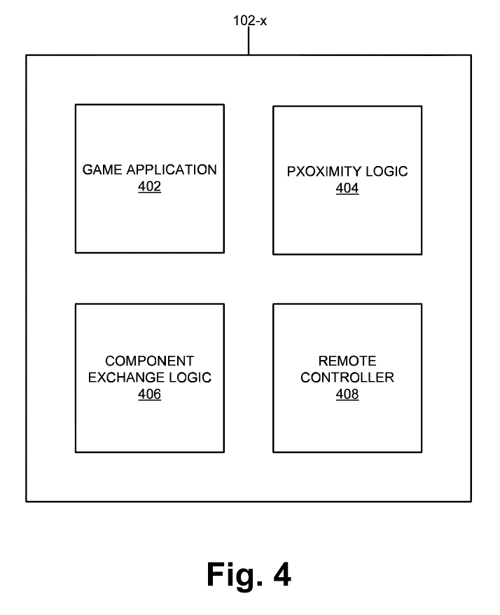

FIG. 4 is a block diagram of exemplary functional components of user device 102-x. As shown, user device 102-x may include game application 402, proximity logic 404, component exchange logic 406, and a remote controller 408. Depending on the implementation, user device 102-x may include additional, fewer, or different functional components than those illustrated in FIG. 4. For example, user device 102-x may include an operating system, document application, etc. In addition, game application 402, proximity logic 404, and component exchange logic 406 may be implemented as a single application/component or, alternatively, three or more stand-alone applications/components.

Game application 402 may include software and/or hardware game that is installed on user device 102-x. In some implementations, game application 402 may include a single-user and/or multi-user game. If game application 402 includes a multi-user game, game application 402 may take the form of a client application that is capable of interacting with other client application via one or more game servers that functions as one or more game hubs. In some implementations, game application 402 on user device 102-x may be controlled from another user device 102-y via remote controller 408 installed in user device 102-y.

Proximity logic 404 may include software and/or hardware components for obtaining a list of user devices 102 that are proximate to or nearby user device 102-x. In some situations, proximity logic 404 may list user devices 102 that are both proximate to user device 102-x and whose addresses (e.g., a network address, a phone number, etc.) are listed in an address book or a phone book installed on user device 102-x.

Component exchange logic 406 may include software and/or hardware components for transmitting of a copy of game application 402, component exchange logic 406, and/or remote controller 408; sending messages to a remote user device 102-x (e.g., user device 102-2) to facilitate remote user device 102-x to obtain a copy of game application 402 from server device 106; and receiving credit when game application 402 is downloaded to the remote user device 102-x as a result of actions taken by component exchange logic 406 on local user device 102-x.

Remote controller 408 may include a component for controlling game application 402. When a copy of remote controller 408 is downloaded from user device 102-x to user device 102-y and installed on user device 102-y, the user at user device 102-x may “share” (e.g., play together) game application 402 running on user device 102-x (or the game running on a server application) with a player at user device 102-y via remote controller 408. Once installed at user device 102-y, remote controller 408 may receive information (e.g., graphics, video information, audio information, etc.) from game application 402 at user device 102-x (or a game from server application) and display game scenes, play sound, and/or provide other interactive game information to the player at user device 102-y. Additionally, remote controller 408 may send control signals from user device 102-y to user device 102-x or to the game at server device 106.

In some situations, it may be preferable for user devices 102 to exchange remote controller 408 rather than game application 402. For example, by not allowing the physical copy of game application 402 to be transferred until a physical copy is purchased, additional security may be provided (e.g., hacking, creating unwanted copies, etc.). In addition, the transfer of a copy of complete game application 402 may be slow and therefore, detrimental to the player experience. As long as user devices 102-x and 102-y are communicating, the user at user device 102-x and player at user device 102-y may share game application 402 experience without delay and with less likelihood of disseminating unauthorized copies of game application 402.

In the above, user device 102-1 may send a copy of game application 402 or remote controller 408 to another device via a user interface. For example, in one implementation, game application 402 or component exchange logic 406 may provide a user interface in which the user may physically contact or “bump” user device 102-1 into user device 102-2 to convey a copy of game application 402 or remote controller 408.

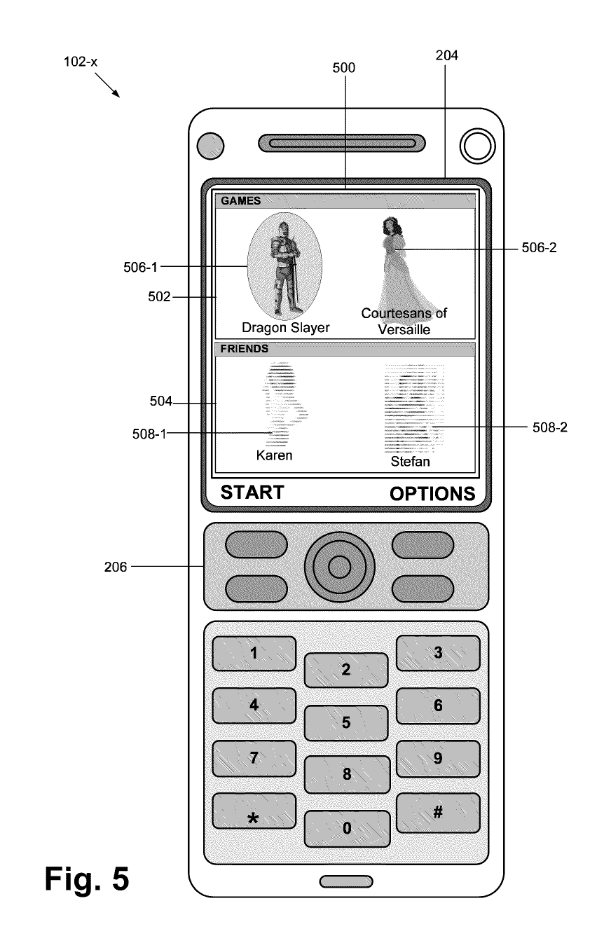

In a different implementation, component exchange logic 406 may provide a graphical user interface (GUI) window via which the user can easily transfer copies of applications from user device 102-1 to user device 102-2. FIG. 5 is a diagram of an exemplary GUI window 500 of component exchange logic 406. As shown, GUI window 500 may include an application list pane 502 and a context user pane 504. Depending on the implementation, GUI window 500 may include additional, fewer, or different components than those illustrated in FIG. 5.

Application list pane 502 may include a list of game applications, such as game applications 506-1 and 506-2 or remote controllers that are associated with applications. In FIG. 5, each of game applications 506-1 and 506-2 are shown as icons and text, although in other implementations, game applications/remote controllers may be represented by just icons or just text. Context user pane 504 may include a list of users or players (e.g., pictures, text, icons, etc.). Context user pane 504 may pop up when the user selects a particular game application/remote controller, such as game application 506-1, via one of control buttons 206. By further use of control buttons 206, the user may select a player to whom the user wants to send a selected game application/remote controller (e.g., game application 506-1) or a message to facilitate obtaining the selected game application by the player.

In sending the copy of game application 402, component exchange logic 406 may provide for the copy of game application 402 to be used for a trial period (e.g., to expire on a particular date or at a particular time). For example, game application 402 may configure the copy of game application 402 to be playable for a limited duration or a limited number of times. In a different implementation, game application 402 may notify server device 106 that administers game application 402. The notification may indicate that a specific copy of game application 402 has been provided to user device 102-2. In response, server device 106 may permit the copy to be played over a particular time period or for a particular number of times.

To transmit the copy of game application 402/remote controller 408 to user device 102-2, component exchange logic 406 may establish a communication link with user device 102-2, using, for example, Bluetooth, a near-field communications, wireless LAN, or a mobile phone communication link (e.g., GSM).

In some implementations, rather than sending the copy of game application 402 or remote controller 408, component exchange logic 406 may send a message to user device 102-2. Such a message may include a link to a site (e.g., a site on server device 106) from which a copy of game application 402 may be downloaded over network 104. When a player at user device 102-2 activates the link via, for example, a browser, user device 102-2 may send bookkeeping information related to game application 402, a request to download a copy of game application 402, and information describing various parameters related to the copy of game application (e.g., a purpose for downloading the copy (e.g., a trial run)) to server device 106. In response, server device 106 may configure and send a copy of game application 402 to user device 102-2.

In addition to facilitating a user of user device 102-2 to obtain a copy of game application 402/remote controller 408, component exchange logic 406 may provide information to server device 106 to credit the user of user device 102-1 for marketing game application 402 to other parties. In response to the information, server device 106 may provide credit to the user of user device 102-1 for motivating the player at user device 102-2 to obtain the copy. The credit may be provided, for example, as a discount coupon (e.g., for purchasing another game or product), cash (e.g., credit to the user's bank account), a reduction in monthly subscription fee associated with game application 402 (e.g., fee for connecting to a server application that allows multiple players to interact), etc. In some implementations, the user may receive credit when the player at user device 102-2 purchases game application 402 within a particular period of time.

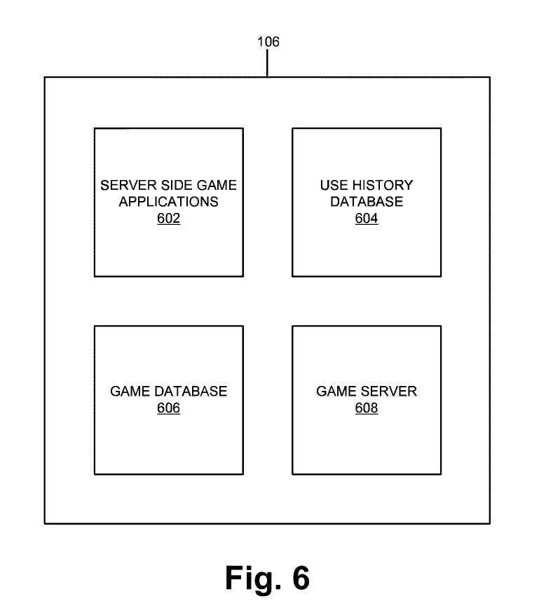

FIG. 6 is a block diagram of exemplary functional components of server device 106. As shown, server device 106 may include server side game applications 602, use history database 604, game database 606, and game server 608. Depending on the implementation, server device 106 may include additional, fewer, or different components than those illustrated in FIG. 6. For example, server device 106 may not include server side game applications 602 and/or use history database 604.

Server side game applications 602 may include one or more game applications that serve or administer client games, such as game application 402, or interact with remote controller 408. Each of server side game applications 602 may exchange information with game applications 402/remote controller 408 on user devices, allowing each game application 402/remote controller 408 on user device 102-x to interact with other game applications 402 on other user devices 102.

Use history database 604 may include records that describe, for each user or user device 102-x, game application 402/remote controller 408 that is installed on user device 102-x, times at which game application 402/remote controller 408 has been engaged in separate gaming sessions, identification information associated with user device 102-1 or the user that facilitated the download of game application 402 or remote controller 408 to user device 102-2, identities of user devices 102 or players that obtained game application 402/remote controller 408 from user device 102-1, registration information or a license number associated with a particular copy of game application 402 installed on user device 102-1, an expiration date of game application 402 on user device 102-2 or a number of times that game application 402 may be played before game application 402 is disabled, a discount that may be applied to game application 402 if game application 402 is purchased by the player at user device 102-2 within a time period, etc.

Game database 606 may include a library of game applications that may be downloaded or distributed to user devices 102.

Game server 608 may include software and/or hardware components for distributing game applications in game database 606 to user devices 102 or other devices. In some instances, game server 608 may forward a copy of a game application in game database 606 to user device 102-2 when the player at user devices 102-2 purchases the game application. In other instances, game server 608 may forward a copy to user device 102-2 when the player at user device 102-2 activates a link and/or other mechanisms that are delivered to user device 102-2 via one or more messages from user device 102-1 or server device 106.

When game server 608 forwards a copy of game application 402 to user device 102-2, game server 608 may credit the user of user device 102-1 for facilitating the transaction. In some implementations, game server 608 may credit the user when the player at user device 102-2 purchases game application 402.

### EXEMPLARY PROCESSES

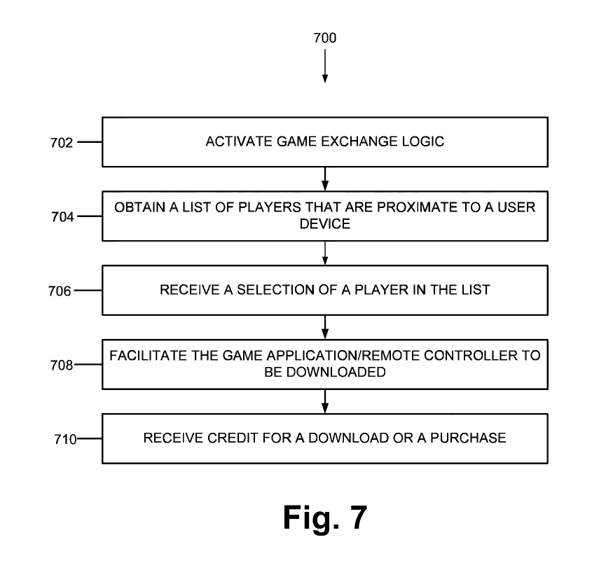

FIG. 7 is a flow diagram of an exemplary process 700 associated with the devices in FIG. 1. Assume that a user is playing game application 402 at user device 102-1, and that the user interacts with a player at user device 102-2. Also assume that the player at user device 102-2 is either proximate to the user at user device 102-1 or is in a contact list of the user (e.g., an address book or a phone book). Process 700 may begin with activating component exchange logic 406 (block 702). Prior to being activated, component exchange logic 406 may have been hibernating, sleeping, operating in a background mode, or not running. The user may activate component exchange logic 406 via a menu system, an input/output component (e.g., one or more of control buttons 206), a GUI window, etc.

Component exchange logic 406 may obtain a list of players that are proximate to user device 102-1 (block 704). Depending on the implementation, component exchange logic 406 may obtain the list of players through different mechanisms. For example, in one implementation, component exchange logic 406 may obtain the list of potential players from the user's contact list.

In another example, component exchange logic 406 may send a query to each of players/user devices 102 that are in the contact list of user device 102-1. The query may request, for example, user device 102-2 to provide the location of user device 102-2 with respect to user device 102-1. Such a query may be sent over either a near-field communication link, Bluetooth, or another type of communication link (e.g., GSM) between user devices 102-1 and 102-2. In yet another implementation, user device 102-x may obtain the list of other user devices 102 based on a service (e.g., by a service provider) in which user device 102-x is notified of locations of other user devices 102. In these examples, component exchange logic 406 may obtain the list of proximate user devices or players by comparing the locations of user devices 102 to the location of user device 102-1.

Component exchange logic 406 may receive the user's selection of a user in the list of users (block 406). For example, in one example, as shown in FIG. 5, the user may select Karen 508-1 in context user pane 504.

Component exchange logic 406 may facilitate game application 402/remote controller 408 to be downloaded and used at user device 102-2 (block 708). As described above, component exchange logic 406 may send a copy of game application 402, remote controller 408, and/or component exchange logic 406 to user device 102-2. In some implementations, instead of sending the copy of game application 402/remote controller 408 to user device 102-2, component exchange logic 406 may send a message that includes a component (e.g., a script, program, a link, etc.) that is to be activated by the player. When the component is activated, a copy of game application 402 may be downloaded from server device 106 to user device 102-2.

Component exchange logic 406 may receive credit for the player at user device 102-2 downloading game application 402/remote controller 408 or purchasing a copy of game application 402 (block 710). Server device 106 may credit the user of user device 102-1. The credit may be provided in different forms, such as a discount coupon, loyalty points (e.g., points that may be converted into a discount), discount for a service, cash or cash-equivalent, etc. In one implementation, the credit may be provided in the form of extra lives of a character in a game session or as power that is given to the character. Further, one level of credit may be provided for a download, and a higher level of credit may be provided for a purchase.

Once user device 102-2 downloads game application 402/remote controller 408 and launches game application 402/remote controller 408, the user at user device 102-1 may interact with the player at user device 102-2 via game application 402 (e.g., play the game with one another over network 104)/remote controller 408.

### Example

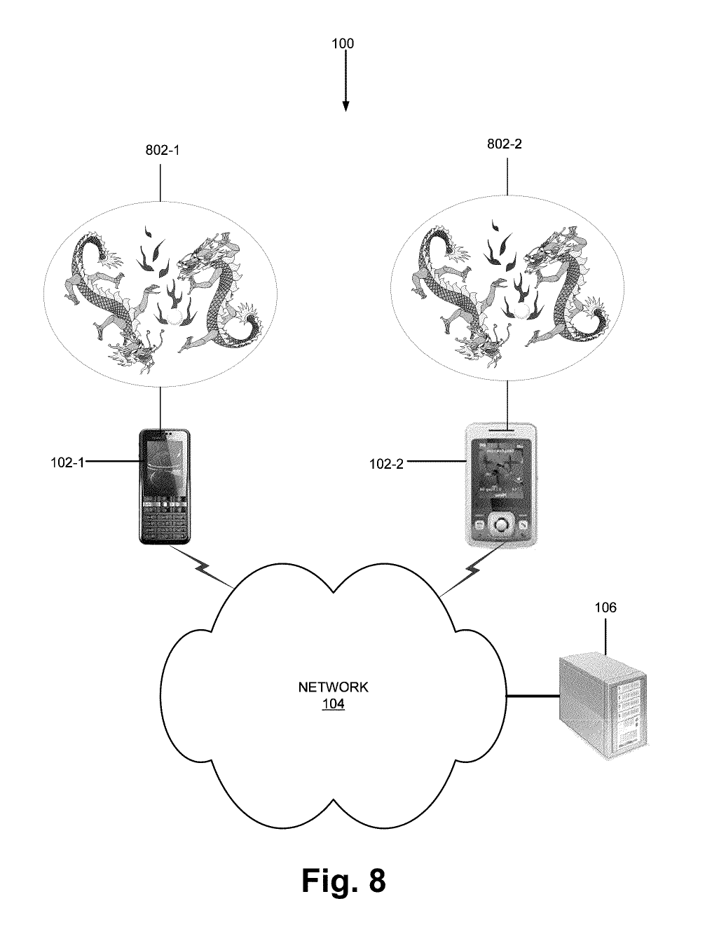

FIG. 8 illustrates an example that is associated with process 700. In FIG. 8, assume that a copy of a game entitled “The Ring of Dragon Fires” 802-1 is installed on user device 102-1. In addition, assume that Tom is at a park and is playing “The Ring of Dragon Fires” 802-1 on user device 102-1.

Susan sees Tom at the park, and Tom explains to Susan how exciting “The Ring of Dragon Fires” 802-1 has been. When Susan indicates that she wants to play the game, Tom views, on user device 102-1, a list of Tom's contacts that are proximate to Tom. Tom finds Susan's name on the list, and sends a message to Susan at user device 102-2. When Susan receives the message on device 102-2, Susan activates a link in the message to download and install “The Ring of Dragon Fires” 802-2 on device 102-2. Upon completion of the installation, Susan plays “The Ring of Dragon Fires” 802-2 with Tom over network 104.

After playing the game few more times, before “The Ring of Dragon Fire” 802-2's trial period expires, Susan becomes fond of playing “The Ring of Dragon Fires” 802-2. Susan may then purchase a copy of “The Ring of Dragon Fires” 802-2 online to continue to play the game. Server device 106 may credit Tom at user device 102-1 with credit, based on the purchase by Susan.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in the above description, user device 102-1 may obtain a list of players that are in a contact list of the user of user device 102-1. In other implementations, user device 102-1 may obtain a list of users/user devices that are anonymous (e.g., not in the contact list), but are proximate to user device 102-1. The user of user device 102-1 may send the game to one of the anonymous devices/users, or a message for facilitating a download of game application 402 to the anonymous device/user. In another example, in still other implementations, in place of game application 402, user devices 102 may exchange or share different types of applications (e.g., an application for sharing a white-board, multimedia application, audio application, communication application, etc.) based on user proximity.

Further, while series of blocks have been described with regard to the exemplary processes illustrated in FIG. 7, the order of the blocks may be modified in other implementations. In addition, non-dependent blocks may represent acts that can be performed in parallel to other blocks. Further, depending on the implementation of functional components, some of the blocks may be omitted from one process.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A device comprising:
a network interface for communicating over a network; and
a processor to:
obtain a list of parties that are associated with user devices proximate to the device,
receive, from a participant, a selection of a party in the list of parties,
send a copy of a component to a first user device associated with the selected party,
start an application session by running an application, and
engage the first user device in the application session, over a communication link, via the component installed at the first user device.

2. The device of claim 1, wherein the device comprises:
a cellular telephone, a game console, a netbook, a laptop, a personal computer, or a personal digital assistant.

3. The device of claim 1, wherein the processor is further configured to:
receive descriptions of locations, from the user devices or a service provider, associated with the user devices.

4. The device of claim 1, wherein the processor is further configured to:
receive information for giving credit to the participant for sending the copy of the component to the first user device; or
receive information for giving credit to the participant when the selected party purchases a copy of the application.

5. The device of claim 1, wherein the component includes at least one of:
the application; or
a controller for the application.

6. The device of claim 1, further comprising:
a memory for storing a contact list for the participant, the contact list including the list of parties.

7. The device of claim 1, wherein the application includes a game application, and wherein the component includes the game application.

8. The device of claim 7, wherein the processor is further configured to at least one of:
configure the copy of the game application to limit a number of times the game application is to be played on the first user device; or
configure the copy of the game application to expire on a particular date.

9. The device of claim 1, wherein the processor is further configured to:
determine a location of the device; and
compare the location of the device to locations of the user devices.

10. A method comprising:
executing a game application installed on a device;
obtaining a list of parties that are stored in a contact list on the device;
receiving a selection of a first party in the list of parties;
generating a message including a component that is to be activated by the first party, the component causing a copy of the game application to be downloaded from a server device when the component is activated; and
sending the message to a user device associated with the first party.

11. The method of claim 10, further comprising:
receiving credit when the first party activates the component and downloads the copy of the game application from the server device.

12. The method of claim 11, wherein receiving credit includes at least one of:
modifying a number of lives of a character or power of the character in the game application;
receiving loyalty points;
receiving a discount for a service; or
receiving a cash-equivalent.

13. The method of claim 10, further comprising:
engaging the user device in a game via the game application.

14. The method of claim 10, wherein obtaining the list of parties includes:
determining locations of the parties; and
identifying parties that are proximate to the participant based on the determined locations.

15. A device comprising:
a network interface for communicating over a network; and
a processor to:
receive a request from a first user device to send a copy of a game application to the first user device, the request identifying a second user device that sent, to the first user device, a message that includes a link or component whose activation caused the first user device to generate and send the request to the device,
transmit a copy of the game application to the first user device; and
transmit information for conveying credit to a user associated with the second user device.

16. The device of claim 15, wherein the game application includes:
a multi-party network game; or
a single-party game.

17. The device of claim 15, wherein the credit includes:
a number of lives of a character or power of the character in the game application;
loyalty points;
a discount for a service; or
a cash-equivalent.

18. The device of claim 15, wherein the second user device comprises:
a cellular telephone, a game console, a netbook, a laptop, or a personal digital assistant.

19. The device of claim 15, wherein the processor is further configured to:
transmit additional information for conveying additional credit to the user associated with the second user device when a party associated with the first user device purchases the copy of the game application.

20. The device of claim 15, wherein the processor is further configured to:
configure the copy of the game application to limit a number of times the game application is to be played on the first user device; or
configure the copy of the game application to expire on a particular date.
